(19) United States
(12) Patent Application Publication
(10) Pub. No.: US 2012/0073996 A1
(43) Pub. Date: Mar. 29, 2012

(54) Collection and Storage Keepsake for Baby Teeth

(76) Inventor: David M. Arnold, Ladera Ranch, CA (US)

(21) Appl. No.: 13/317,404

(22) Filed: Apr. 6, 2010

(51) Int. Cl. A61C 19/10

(52) U.S. Cl. 206/83

(57) ABSTRACT

The container is a clam shell style case in which the top half resembles the bottom half. In each half is an embeddable, non-hardening, polymer material formed into an upper and lower palette and gum line. The cover of the container has a label where the child's name can be written. As the teeth are collected from under the child's pillow, they can be pressed upright into the polymer material.

The container is a clam shell style case in which the top half resembles the bottom half. In each half is an embeddable, non-hardening, polymer material formed into an upper and lower palette and gum line. The lower palette is identified with a prosthetic tongue. The cover of the container has a label where the child's name can be written. As the teeth are collected from under the child's pillow, they can be pressed upright into the polymer material. Once all of the child's teeth are collected, they can be stored as a keepsake and given to the child to explain the Tooth Fairy.

### FIGURES (LEGEND)

FIG. 1—Open View
1. Top Clasp.
2. Top Palate.
3. Hinge.
4. Bottom Palate.
5. Bottom Clasp.

FIG. 2—Closed View

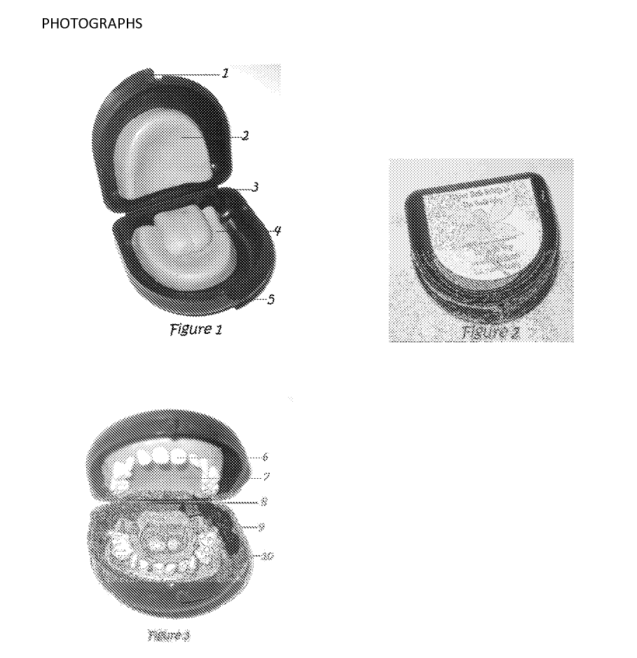

Case in closed position.

FIG. 3—Open View with sample teeth. [Sample teeth not part of claimed design]
6. Sample teeth mounted in upper palette. [Not part of the claimed design. Only used here to display the use of the design.]
7. Top Palate.
8. Hinge.
9. Bottom Palate.
10. Sample teeth mounted in lower palette. [Sample teeth not part of the claimed design. Only used here to display the use of the design.]

1. A container consisting of a clam shell style case with an embeddable, non-hardening polymer material interior replicating the interior of a child's mouth used to imbed the teeth a child loses.

2. Once all of the child's teeth have been collected in the keepsake container they will have been memorialized in the same order and appearance as they were in the child's mouth.

3. When the box is left partially open, it is possible to see the teeth as they were set in the child's mouth before falling out.
